(19) United States
(12) Patent Application Publication
(10) Pub. No.: US 2023/0059040 A1
(43) Pub. Date: Feb. 23, 2023

(54) METHOD FOR SEALING ALUMINUM ALLOYS

(71) Applicants: SAFRAN AIRCRAFT ENGINES, Paris (FR); SAFRAN LANDING SYSTEMS, VELIZY-VILLACOUBLAY (FR)

(72) Inventors: Virginie RELLAND, MOISSY-CRAMAYEL (FR); Myriam AUGROS, MOISSY-CRAMAYEL (FR); Philippe BAYARD, MOISSY-CRAMAYEL (FR); Benjamin MOULS, STRASBOURG (FR); Aimé RAMAKISTIN, STRASBOURG (FR)

(73) Assignees: SAFRAN AIRCRAFT ENGINES, Paris (FR); SAFRAN LANDING SYSTEMS, VELIZY-VILLACOUBLAY (FR)

(21) Appl. No.: 17/794,864

(22) PCT Filed: Jan. 21, 2021
(86) PCT No.: PCT/FR2021/050112

§ 371 Date: Jul. 22, 2022

(30) Foreign Application Priority Data
Jan. 31, 2020 (FR) FR2000978

(51) Int. Cl. C25D 11/24

(52) U.S. Cl. CPC C25D 11/246

(57) ABSTRACT

A method for the surface treatment of an aluminum or aluminum alloy part configured for use in the aviation sector, includes the steps of: i) subjecting said part to an anodization step; ii) treating the anodized part with a post-anodization sealing method according to the invention; and optionally iii) applying one or more layer(s) of paint; or optionally iv) applying a hard anodic oxidation treatment to at least some of the functional areas of the part. A part made of aluminum or aluminum alloy is treated with a post-anodization sealing method, optionally includes one or more layer(s) of paints or optionally having, on certain functional areas, a hard anodic oxidation treatment, wherein the part is configured for use in the aviation sector.

### TECHNICAL FIELD OF THE INVENTION

The present invention is part of the search for new solutions for anti-corrosion protection on aluminium alloys, in particular for aeronautical applications, with orwithout the application of a paint system.

### TECHNICAL BACKGROUND

The technical background comprises in particular the documents US-A1-2002/117 236, US-A1-2006/191 599A1, US-A1-6 663 700, US-A1-2016/047 057 and WO-A1-2013/117 767.

The aluminium alloys are the materials of choice for the transport industry, especially for the aeronautical industry, due to their excellent mechanical properties/weight ratio and their relatively low manufacturing cost. However, these alloys are likely, depending on the environment in which they are found, to be affected by several types of localized corrosion, causing the degradation of the part and possibly leading to its removing or its failure. Many strategies have been implemented to overcome this weakness, and among them, the formation or the deposition of a protective layer on the surface of the alloys is the most widely used. This is the case in particular for the protective layers obtained by the anodization method for the aluminium alloys.

The anodization is an electrolytic method that substitutes the natural oxide (native oxide), a few nanometres thick, which covers the aluminium, with a layer of oxide that can go up to several micrometres. The oxide layers produced by anodizing range in thickness from two microns to about fifteen microns to provide long-term corrosion protection. The anodization, also referred to as anodic oxidation, consists of forming a porous aluminium oxide/hydroxide layer on the surface of the part, referred to as anodic layer, by applying a current to the part immersed in an electrolytic bath containing a strong acid type electrolyte, the part constituting the anode of the electrolytic system. The layer thus formed on the surface of the part, after a sealing treatment, allows to reinforce the corrosion resistance of the part. The anodization treatments are nowadays commonly used in the aeronautical industry, mainly to improve the corrosion resistance of the parts, and thus their service life, but also to facilitate the adhesion of organic layers (paints). However, the anodization method, is directly impacted by the European regulations (REACH), which, since September 2017, prohibits (or restricts to authorization) the use of certain key components in the surface treatments, in particular, hexavalent chromium. Hexavalent chromium is present in the anodization treatment of the OAC type (Chromic Anodic Oxidation as described, for example, in https://www.a3ts.org/actualite/commissions-techniques/fiches-techniques-traitement-surface/anodisation-chromique/), but also in the usual surface preparation pretreatments, aiming at cleaning/pickling the surfaces of the parts before the anodization treatment, and finally in the final treatments referred to as sealing, whose objective is to close the pores of the anodic layer formed during the anodization treatment.

Different methods have been proposed to replace the OAC and OAS (Sulfuric Anodic Oxidation) treatments sealed with hexavalent chromium, which are impacted by the European regulation REACH:
OAS NG (new generation sulfuric anodic oxidation as described for example in https://www.a3ts.org/actualite/commissions-techniques/fiches-techniques-traitement-surface/anodisation-sulfurique-version-5-2/) has been proposed to replace the OAS;
OAST (sulfo-tartaric anodic oxidation as described, for example, in https://www.a3ts.org/actualite/commissions-techniques/fiches-techniques-traitement-surface/anodisation-sulfo-tartrique-oast-tartric-sulfuric-anodizing-tsa/) has been proposed to replace the OAC.

The OAC can also be replaced by OAS NG FE (new generation fine-thickness sulfuric anodic oxidation) which is an anodization of the OAS NG type whose anodization parameters (voltage, immersion time) have been adapted to obtain an anodization layer with a thickness of between 2 and 7 µm.

Although current conventional anodization solutions, such as OAS NG followed by hot water sealing, implement treatment ranges that are compatible with European regulations REACH, they are still unsatisfactory or unsatisfactory in terms of anti-corrosion protection on certain grades of aluminium alloys referred to as “difficult”. Non-limiting examples of aluminium alloys referred to as “difficult” include the alloys 2214, 2618A or AU5NKZr. These alloys have particular microstructures due to their chemical composition, which give them either casting-type defects or precipitates such as intermetallic rich in copper or iron or nickel, etc. Thus, when the anodic layer is formed on the surface of these alloys, layer defects may reside, leading to certain local brittleness sensitive to the corrosion.

For these alloys, it is therefore necessary to optimize the anodization ranges in order to improve the anti-corrosion performance.

There is therefore a real need to optimize the current anodization methods for metal alloys, in particular aluminium alloys referred to as “difficult”, in order to improve the anti-corrosion performance of these alloys.

There is also a real need to optimize the current anodization methods for metal alloys, in particular for aluminium alloys referred to as “difficult”, in order to improve the anti-corrosion performance of these alloys, while meeting the requirements of the European regulation REACH.

The present invention is intended to overcome the disadvantages of the current anodization methods for metal alloys, in particular aluminium alloys, particularly aluminium alloys referred to as difficult, in terms of the corrosion resistance of said alloys.

### SUMMARY OF THE INVENTION

The present invention is precisely intended to meet these needs, in particular, in terms of corrosion resistance of aluminium alloys, in particular of the 2xxx, 6xxx and 7xxx series, of aluminium casting alloys such as AS7G06, AS7G03, AS10G or AS9U3, of aluminium alloys resulting from methods such as additive manufacturing, and of aluminium alloys referred to as difficult, by providing a method for post-anodization sealing aluminium or aluminium alloy, comprising at least the following steps:

A) a step of impregnating the anodized aluminium or aluminium alloy, in an aqueous bath of demineralized water containing
   a hexafluorozirconate salt selected from the group consisting of ammonium hexafluorozirconate((NH4)_{2ZrF6}), sodium hexafluorozirconate (Na2ZrF6), potassium hexafluorozirconate (K2ZrF6), and
   a trivalent chromium salt selected from the group consisting of CrF₃,xH₂O, CrCI₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O, at a temperature between 20 and 80° C.;
B) a sealing step carried out in an aqueous solution of deionized water having a conductivity less than or equal to 100 µS/cm containing between 1 and 500 g/L of an alkali metal or alkaline earth metal silicate, at a temperature of between 60 and 100° C.;
C) a post-sealing rinsing step with a deionized water having a conductivity less than or equal to 100 µS/cm and at a temperature between 15 and 75° C.

In the impregnation step A), the hexafluorozirconate salt concentration is between 0.5 and 50 g/L. The concentration of trivalent chromium salt in this step is between 0.1 and 50 g/L.

Intermediate rinses, in particular with the demineralized water, are preferably carried out
between the steps A) and B), and/or
before and/or after the treatment of the part by anodization.

Since the anodization layers have a very porous structure, when the chemical and/or corrosion resistance is of primary importance, the anodizing layer must be sealed. This implies that the aluminium oxide layer is transformed into an aluminium hydroxide complex where the pores are closed. Therefore, the sealing, in addition to the anodization, is decisive for the quality of the anodization layer because:
the sealing of the pores leads to an increase in corrosion resistance;
the fouling is avoided;
leaching of dyes out of the pores is avoided.

The post-anodization sealing method of the invention allows to obtain a coating with very high anti-corrosion properties on the aluminium alloys referred to as difficult such as 2618A and 2214, but also on the most common aluminium alloys in the aeronautical field, such as 2024 or 7175 for example.

The sealing method of the invention can be applied to various anodization known to the person skilled in the art, including OAST, OAS NG FE, OAS NG.

It may or may not be followed by a paint application, and can also be used as a sparing treatment to the HAO (Hard Anodic Oxidation) treatment.

The invention also relates to a method for treating the surface of an aluminium or aluminium alloy part for use in the aeronautical sector comprising at least the following steps:
i) subjecting said part to an anodization step, having possibly previously undergone a surface preparation step (degreasing, then pickling);
ii) treating the anodized part by a post-anodization sealing method according to the invention; and optionally
iii) applying one or more layers of paint.

The invention also relates to a method for treating the surface of an aluminium or aluminium alloy part intended for use in the aeronautical sector comprising at least the following steps:
i) subjecting said part to an anodization step, having possibly previously undergone a surface preparation step (degreasing, then pickling);
ii) treating the anodized part by a post-anodization sealing method according to the invention; and optionally
iv) applying a HAO treatment on at least one portion of the functional areas of the part.

Another embodiment of the invention is the use of a post-anodization sealing method according to the invention, in the surface treatment of aluminium or aluminium alloy parts intended for the aeronautical sector.

Another embodiment of the invention is an aluminium or aluminium alloy part treated by a post-anodization sealing method according to the invention, possibly comprising one or more layers of paint and intended for the aeronautical sector.

The invention also has as its embodiment an aluminium or aluminium alloy part treated by a post-anodization sealing method according to the invention, possibly comprising on at least one portion of the functional areas, a HAO (Hard Anodic Oxidation) treatment providing an anti-wear protection on these areas, said part being intended for the aeronautical sector.

### BRIEF DESCRIPTION OF THE FIGURES

Further characteristics and advantages of the invention will become apparent from the following detailed description, for the understanding of which reference is made to the attached drawings in which:

FIG. 1 shows a cross-sectional diagram of the layer formed with the sealing method of the invention.

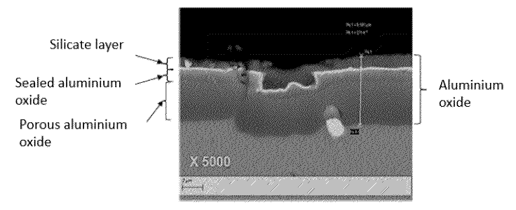

### DETAILED DESCRIPTION OF THE INVENTION

The present invention is specifically intended to meet the needs of the prior art, in particular, in terms of corrosion resistance of aluminium alloys, especially of the 2xxx, 6xxx and 7xxx series, foundry alloys, and aluminium alloys resulting from methods such as additive manufacturing and aluminium alloys referred to as difficult, by providing a method for post-anodization sealing of aluminium or aluminium alloy, comprising at least the following steps:
A) a step of impregnating the anodized aluminium or the aluminium alloy in an aqueous bath of demineralized water containing
   a hexafluorozirconate salt selected from the group consisting of ammonium hexafluorozirconate((NH4)_{2ZrF6}), sodium hexafluorozirconate (Na2ZrF6), potassium hexafluorozirconate (K2ZrF6), and
   a trivalent chromium salt selected from the group consisting of CrF₃,xH₂O, CrCI₃,xH₂O, Cr(NO₃)₃,xH₂O, (CH₃CO₂)₂Cr,xH₂O, (CH₃CO₂)₇Cr₃(OH)₂,xH₂O, Cr₂(SO₄)₃,xH₂O, CrK(SO₄)₂,xH₂O, at a temperature between 20 and 80° C.;
B) a sealing step carried out in an aqueous solution of deionized water having a conductivity less than or equal to 100 µS/cm containing between 1 and 500 g/L of an alkali metal or alkaline earth metal silicate, at a temperature of between 60 and 100° C., preferably between 97° C. and 100° C., for example equal to 98° C.;
C) a post-sealing rinsing step in a deionized water having a conductivity less than or equal to 100 µS/cm and at a temperature between 15 and 75° C.

The trivalent chromium salt can be, for example, one of the following commercial products: Surtec 650 from the company SURTEC, Lanthane 613.3 from the company COVENTYA, TCS from the company SOCOMORE.

Intermediate rinses, in particular with the demineralized water, are preferably carried out
between the steps A) and B), and/or
before and/or after the treatment of the part by anodization.

The optimized sealing method of the invention may be suitable for any type of aluminium alloy, including alloys referred to as “difficult”, in particular aluminium alloys of the 2xxx, 6xxx and 7xxx series, previously anodized by various methods, for example, by the OAST (sulfo-tartaric anodic oxidation), OAS NG FE (new generation fine-thickness sulfuric anodic oxidation) or OAS NG (new generation sulfuric anodic oxidation) methods.

Furthermore, the post-anodization sealing method of the invention is compatible with the requirements associated with the European regulation REACH and leads to a good anti-corrosion protection on the aluminium alloys referred to as “difficult” (e.g. 2618A, 2214 and AUSNKZr). This object method can be followed or not by a paint application.

Furthermore, this method can also be used as a sparing treatment for HAO treatment. Some aeronautical parts have both an anti-corrosion protection treatment of the OAC, OAS, OASNG, or OASNGFE type and an anti-wear protection treatment on some functional areas obtained by a HAO treatment. In the HAO implementation ranges, the initial anti-corrosion treatment (OAC, OAS, OASNG, or OASNGFE) can be carried out first. The HAO treatment can be carried out secondly on the bare aluminium areas (either the areas have been masked prior to the OAC, OAS, OASNG, or OASNGFE treatment, or they have been treated with OAC, OAS, OASNG, or OASNGFE and then uncovered by machining to accommodate the HAO treatment). Thus, the part pre-anodized by OAC, OAS, OASNG, or OASNGFE treatment serves as a spare for HAO treatment. In the prior art, the sealing with base of chromium VI of the OAC or OAS methods had the advantage of being presented as resistant to the HAO method so that it was not necessary to mask the pre-anodized parts before carrying out the HAO method. The OAC or OAS thus acted as a spare to the HAO, without degrading the performance of the OAC or OAS (no rework of HAO on the OAC or OAS and maintenance of the initial anti-corrosion properties). The new treatments in compliance with the European regulation REACH, such as OAST, OAS NG or OAS NG FE sealed with hot water alone, are not robust enough to play the role of HAO sparing: this results in HAO rework phenomena on the areas pre-anodized by OAST LC, OAS NG or OAS NG FE (sparing treatments), depending on many method parameters (electrical cycle, alloy, anodization layer thickness, etc.), implying a significant degradation of the corrosion resistance of the sparing treatments. The post-anodization sealing method of the invention allows to ensure the role of sparing at the HAO. Thus, the anti-corrosion performance of the aluminium alloys pre-treated by said method of the invention is maintained after the HAO treatment is carried out on the defined functional areas.

Thus, the post-anodization sealing method of the invention allows to obtain a coating with very high anti-corrosion properties on aluminium alloys of the 2xxx, 6xxx and 7xxx series and on difficult aluminium alloys, but also on the most common aluminium alloys in the aeronautical field, such as 2024 and 7175, and on the aluminium alloys referred to as “difficult” such as 2618A and 2214. This method also plays the role of sparing the HAO.

The method of the invention is particularly suitable for aluminium and aluminium alloy parts of the 2xxx, 6xxx and 7xxx series, in particular selected from the group consisting of 2014, 2017, 2024, 2214, 2219, 2618, AU5NKZr, 7175, 5052, 5086, 6061, 6063, 7010, 7020, 7050, 7050 T7451, 7055, 7068, 7085, 7075, 7175, and 7475, aluminium casting alloys of the type AS7G06, AS7G03, AS10G, and AS9U3, aluminium alloys resulting from methods such as the additive manufacturing.

During the impregnation step A), the hexafluorozirconate salt concentration is between 0.5 and 50 g/L, for example 2 g/L. The concentration of trivalent chromium salt in this step is between 0.1 and 50 g/L, for example 1 g/L.

The temperature of the bath in step A) can be between 20 and 80° C., preferably between 20 and 60° C., more preferably between 35 and 60° C., for example between 35 and 45° C.

The pH of the bath in step A) is between 3 and 5, preferably between 3.5 and 4.5, for example between 3.7 and 4.2.

The duration of the impregnation in the bath in step A) is between 1 and 40 minutes, preferably between 5 and 30 minutes, for example between 5 and 20 minutes.

The impregnation step A) is followed by a step B) which is a sealing step. The sealing of the step B) is carried out in an aqueous solution of deionized water with a conductivity of less than or equal to 200 µS/cm, preferably between 1 and 100 µS/cm, for example between 1 and 50 µS/cm.

The temperature of the aqueous solution in the step B) is preferably between 80 and 100° C., for example between 80 and 98° C.

The alkali metal or alkaline earth metal silicate can be selected from the group consisting of lithium silicate, sodium silicate, potassium silicate, calcium silicate and magnesium silicate.

During the sealing step B), the concentration of alkali metal or alkaline earth metal silicate in the solution is preferably between 1 and 500 g/L, for example between 5 and 100 g/L.

The duration of the sealing step B) is between 1 and 40 minutes, preferably between 5 and 35 minutes, for example between 5 and 30 minutes.

The pH of the sealing solution is between 9 and 12, preferably between 10 and 11.5 minutes, for example between 10.5 and 11.4.

The sealing is followed by a rinsing step C) in a deionized water having a conductivity lower than or equal to 100 µS/cm, preferably between 1 and 100 µS/cm, more preferably between 10 and 100 µS/cm for example between 10 and 50 µS/cm.

The post- sealing rinsing is preferably carried out at a temperature of between 10 and 75° C., for example between 15 and 60° C.

The pH of the water in step C) is between 4.5 and 8.5, preferably between 5 and 8, for example between 5.5 and 7.5.

The duration of the post-sealing rinsing is between 10 seconds and 10 minutes, preferably between 10 seconds and 5 minutes, for example between 30 seconds and 2 minutes.

It has been found, quite unexpectedly, that the combination of the steps of impregnation + sealing + post-sealing rinsing, as described below, is essential to ensure a good anti-corrosion performance of aluminium or aluminium alloy.

Intermediate rinses, in particular with demineralized water, can be carried out between the steps described above.

Before the aluminium or aluminium alloy is subjected to the anodization step, the aluminium or aluminium alloy may be subjected to a surface preparation step by degreasing and/or pickling so as to remove grease, dirt and oxides from its surface.

This preliminary step of surface preparation can comprise one or more of the following operations:
solvent degreasing, to dissolve grease on the surface of aluminium or aluminium alloy. This operation can be carried out by soaking, spraying, or any other method known to the person skilled in the art;
alkaline degreasing, to dissolve grease on the surface of aluminium or aluminium alloy. This operation can be carried out by soaking, spraying, or any other technique known to the person skilled in the art;
alkaline pickling, to dissolve naturally the oxides formed on the surface of aluminium or aluminium alloy. This operation can be carried out by soaking, spraying, or any other technique known to the person skilled in the art. At the end of this operation, the aluminium or aluminium alloy is covered with a powdery layer of oxidation products of intermetallic compounds, which must be removed by an acid pickling step;
acid pickling, to dissolve the oxides naturally formed on the surface of the aluminium or aluminium alloy, and/or the oxidation layer formed on the surface of the part during the alkaline pickling step. This operation can be carried out by soaking, spraying, or any other technique known to the person skilled in the art.

The preliminary step of surface preparation of the aluminium or aluminium alloy by degreasing and/or pickling to remove grease, dirt and oxides present on its surface can be performed under the conditions described, for example, in the application WO 2013/117759.

Intermediate rinses, in particular with demineralized water, are preferably carried out between the above successive steps and before the part is treated by anodization.

Prior to the application of the sealing method of the invention, the aluminium or aluminium alloy, possibly subjected to a surface preparation step by degreasing and/or pickling by one or more of the operations described above, is anodized. Any type of anodization on aluminium known to the person skilled in the art can be used. In this respect, we can mention
OAS: Sulfuric Anodic Oxidation (Chromium VI based sealing, method impacted by the European regulation REACH),
OAC: Chromic Anodic Oxidation (Chromium VI based, method impacted by the European regulation REACH),
OAST: SulfoTartaric Anodic Oxidation,
OAST: SulfoTartaric Anodic Oxidation,
OAS NG FE: New Generation Fine Thickness Sulfuric Anodic Oxidation,
OAS NG: New Generation Sulfuric Anodic Oxidation.

In the context of the present invention, the OAST LC, OAS NG FE, OAS NG anodization methods are preferred.

The surface treatment method of the invention significantly improves the corrosion resistance properties of metal or metal alloy parts, in particular aluminium or aluminium alloy parts, and complies with the requirements of the European regulation REACH.

The method of the invention is of great interest in any type of industry where one seeks to improve the corrosion resistance properties of metal or metal alloy parts, in particular aluminium or aluminium alloy parts, such as in the aeronautics, the motor vehicle, the oil industry, etc.

The method according to the invention may comprise one or more of the following characteristics and/or steps, taken alone or in combination with each other:
the aluminium alloy is an aluminium alloy of the 2xxx, 6xxx and 7xxx series, in particular selected from the group consisting of 2014, 2017, 2024, 2214, 2219, 2618, AU5NKZr, 7175, 5052, 5086, 6061, 6063, 7010, 7020, 7050, 7050 T7451, 7055, 7068, 7085, 7075, 7175, and 7475, aluminium casting alloys of the AS7G06, AS7G03, AS10G, and AS9U3 type, and aluminium alloys resulting from methods such as the additive manufacturing;
in the impregnation step A), the hexafluorozirconate salt concentration is between 0.5 and 50 g/L;
in the impregnation step A), the concentration of trivalent chromium salt is between 0.1 and 50 g/L;
the sealing of the step B) is carried out in an aqueous solution of deionized water with a conductivity between 1 and 100 µS/cm;
the alkali metal or alkaline earth metal silicate is selected from the group consisting of lithium silicate, sodium silicate, potassium silicate, calcium silicate and magnesium silicate;
the concentration of alkali metal or alkaline earth metal silicate in the solution is between 5 and 100 g/L;
the rinsing step C) is carried out in deionized water with a conductivity between 1 and 100 µS/cm.

The invention also relates to a method for surface treating an aluminium or aluminium alloy part intended for use in the aeronautical sector comprising at least the following steps:
i) subjecting said part to an anodization step, having possibly previously undergone a surface preparation step (degreasing, then pickling);
ii) treating the anodized part by a post-anodization sealing method according to the invention; and optionally
iii) applying one or more layers of paint.

The invention also relates to a method for surface treating an aluminium or aluminium alloy part intended for use in the aeronautical sector comprising at least the following steps:
i) subjecting said part to an anodization step, having possibly previously undergone a surface preparation step (degreasing, then pickling);
ii) treating the anodized part by a post-anodization sealing method according to the invention; and optionally
iv) applying a HAO treatment on at least one portion of the functional areas of the part.

Another object of the invention is the use of a post-anodization sealing method according to the invention, in the surface treatment of aluminium or aluminium alloy parts intended for the aeronautical sector.

Another object of the invention is an aluminium or aluminium alloy part treated by a post-anodization sealing method according to the invention, possibly comprising one or more layers of paint and intended for the aeronautical sector.

The invention also has as its object a part made of aluminium or aluminium alloy treated by a post-anodization sealing method according to the invention, possibly comprising on at least one portion of the functional areas, a HAO (Hard Anodic Oxidation) treatment providing an anti-wear protection on these areas, said part being intended for the aeronautical sector. This part can be surface treated by a treatment method as described above.

The method of the invention is also applicable for the following applications:
Hard Anodic Oxidation (HAO) sparing treatment: some aeronautical parts require a HAO treatment on certain functional areas where an anti-wear protection is needed. The invention is compatible with treatments used in HAO sparing, such as OAC, OAS, OAST LC, OAS NG FE, or OAS NG;
Anodization treatment followed by a paint application: some aeronautical parts have a paint treatment after anodization in order to reinforce the anti-corrosion protection. The invention is compatible with various paint systems.

Other advantages and characteristics of the invention will become apparent from the examples given below by way of illustration.

### EXAMPLES

### Example 1

Method for post-anodization sealing of aluminium alloy parts

Aluminium alloy parts 2024 T351 and 2618A T851 with dimensions 120x100x5 mm are treated according to the methods described below.

The surface preparation steps of the part are first carried out successively:
Alkaline degreasing, by soaking the part in a solution of SOCOCLEAN A3431 at 10% by volume, at a temperature of 40° C., for 5 minutes;
Rinsing with tap water or demineralized water;
Acid pickling by soaking the part in a mixture of SOCOSURF A1858 at 50% by volume and SOCOSURF A1806 at 10% by volume at a temperature of 50° C. for 10 minutes;
Rinsing with tap water or demineralized water.

The pickled and rinsed parts are then subjected to an anodization method using the conventional methods of chromic anodization (OAC), new generation sulfuric anodization (standard thickness or fine thickness (FE)), and sulfo-tartaric anodization (OAST).

The operating parameters for the different anodization are shown in Table 1 below.

Table 1

| | | | | |
|---|---|---|---|---|
| | OAC | OAST | OAS NG | OAS NG FE |
| Composition of the bath | CrO_{3:} 40 - 60 g/L | C₄H₆O₆: 72 - 88 g/L H₂SO₄: 36 - 44 g/L | H₂SO₄: 150- 220 g/L | H₂SO₄: 150 - 220 g/L |
| Temperature of the bath | 38 -42° C. | 36 -39° C. | 16 -20° C. | 16 -20° C. |
| Thickness of the formed layer (µm) | 2 - 7 µm | 4 - 7 µm | 8 - 15 µm | 2 - 7 µm |

The anodized parts according to the invention are then subjected to the sealing method according to the invention under conditions and in the order indicated below in:
step A): an impregnation step of said parts, successively, in an aqueous bath containing 2 g/L of ((NH4)₂ZrF₆) and 0.5 g/L of Cr2(SO₄)₃,xH₂O, at a temperature of 40° C. for 10 minutes and at a pH of 3.9, then
step B): a sealing by immersion of the parts in an aqueous solution of deionized water having a conductivity lower than 100 µS/cm with 80 g/L of a sodium silicate, a temperature of 98° C. and for 20 minutes; and
step C): a post-sealing rinsing by immersion of the parts after the three previous sealing operations in deionized water with a conductivity lower than 100 µS/cm, at a temperature of 20° C. during 1 minute.

Between each step a rinse with demineralized water is performed.

These conditions are shown in [Table 2].

Table 2

| | Impregnation | sealing | Post-sealing rinsing |
|---|---|---|---|
| Composition of the bath | ((NH₄)₂ZrF₆) = 2 g/L (Cr₂(SO₄)₃,xH₂O) = 0.5 g/L of | Deionized water (conductivity ≤ 100 µS/cm) + sodium silicate 80 g/L | Deionized water (conductivity ≤ 100 µS/cm) |
| Temperature of the bath | 35 to 45° C. | 98° C. | 20° C. |
| pH of the bath | 3.7 - 4.2 | 10.5 -11.4 | 5.5 - 7.5 |
| Processing time | 5 to 20 minutes | 5 to 30 minutes | 10 s to 2 min |

Corrosion resistance results evaluated on various anodized and sealed alloys by the conventional sealing methods and by the method of the invention:

By way of comparison, the aluminium alloy parts anodized according to the conventional methods indicated in [Table 1], are then subjected to one or more conventional sealing operations such as hexavalent chromium salt sealing, hydrothermal sealing according to the conventional methods known to the person skilled in the art and compared to the parts anodized and sealed by the method of the invention. The treated parts are subjected to a salt spray test in accordance with the standard NF EN ISO 9227. The results are shown in [Table 3].

Table 3

Neutral salt spray after 500h No. of bites/dm² (average over 3 parts))

| Type of anodization | 2024 T351 | 2618A T851 |
|---|---|---|
| OAC sealing with hexavalent chromium salts | < 1 | 6 |
| OAS NG FE sealing hydrothermal | 6 | 6 |
| OAS NG FE sealing according to the invention | 0 | 0 |
| OAST LC sealing hydrothermal | < 1 | 5 |
| OAST LC sealing according to the invention | 0 | 0 |

From the data presented in [Table 3], it can be observed that anodization ranges containing hexavalent chromium-based products, such as for example OAC, or anodization ranges compatible with the requirements of the European regulation REACH, such as OAS NG, lead to lower salt corrosion resistance performance.

The anodization treatments followed by a sealing according to the invention based on silicates obtain, on the other hand, much better anti-corrosion performances.

In the method of the invention, the combination of the 3 steps, impregnation + sealing + post-sealing rinsing, seems to be essential to guarantee good anti-corrosion performance.

1. A method for post-anodization sealing aluminum or aluminum alloy, comprising at least the following steps:
A) a step of impregnating an anodized aluminum or aluminum alloy, in an aqueous bath of demineralized water containing;
a hexafluorozirconate salt selected from the group consisting of ammonium hexafluorozirconate ((NH4)2ZrF6), sodium hexafluorozirconate (Na2ZrF6), and potassium hexafluorozirconate (K2ZrF6), and
a trivalent chromium salt selected from the group consisting of CrF3,xH2O, CrC13,xH2O, Cr(N03)3,xH2O, (CH3CO2)2Cr,xH2O, (CH3CO2)7Cr3(OH)2,xH2O, Cr2(SO4)3,xH2O, and CrK(S04)2,xH2O,
at a temperature between 20 and 80° C.;
B) a sealing step carried out in an aqueous solution of deionized water having a conductivity less than or equal to 100 µS/cm containing between 1 and 500 g/L of an alkali metal or alkaline earth metal silicate, at a temperature of between 60 and 100° C.; and
C) a post-sealing rinsing step in a deionized water having a conductivity less than or equal to 100 µS/cm and at a temperature between 15 and 75° C.

2. The method according to claim 1, wherein the aluminum alloy is an aluminum alloy of the 2xxx, 6xxx and 7xxx series, in particular selected from the group consisting of 2014, 2017, 2024, 2214, 2219, 2618, AU5NKZr, 7175, 5052, 5086, 6061, 6063, 7010, 7020, 7050, 7050 T7451, 7055, 7068, 7085, 7075, 7175 et 7475, aluminum foundry alloys type AS7G06, AS7G03, AS10G and AS9U3, aluminum alloys resulting from methods such as additive manufacturing.

3. The method according to claim 1, wherein in the impregnation step A), the hexafluorozirconate salt concentration is between 0.5 and 50 g/L.

4. The method according to claim 1, wherein in the impregnation step A), the concentration of trivalent chromium salt is between 0.1 and 50 g/L.

5. The method according to claim 1, wherein the sealing of the step B) is carried out in an aqueous deionized water solution having a conductivity between 1 and 100 µS/cm.

6. The method according to claim 1, wherein the alkali metal or alkaline earth metal silicate is selected from the group consisting of lithium silicate, sodium silicate, potassium silicate, calcium silicate, and magnesium silicate.

7. The method according to claim 1, wherein the concentration of alkali metal or alkaline earth metal silicate in the solution is between 5 and 100 g/L.

8. The method according to claim 1, wherein the rinsing step C) is carried out in a deionized water having a conductivity between 1 and 100 µS/cm.

9. A method for treating a surface of an aluminum or aluminum alloy part for use in the aeronautical sector, comprising at least the following steps:
i) subjecting said part to an anodization step, having possibly previously undergone a surface preparation step (degreasing, then pickling);
ii) treating the anodized part by a post-anodization sealing method according to the method of claim 1; and
iii) applying one or more layers of paint.

10. A method for treating a surface of an aluminum or aluminum alloy part configured for use in the aeronautical sector, comprising at least the following steps:
i) subjecting said part to an anodization step, having possibly previously undergone a surface preparation step (degreasing, then pickling); and
ii) treating the anodized part by a post-anodization sealing method according to claim 1.

11. A use of a post-anodization sealing method according to claim 1, in the surface treatment of aluminum or aluminum alloy parts configured for the aeronautical sector.

12. An aluminum or aluminum alloy part treated by a post-anodization sealing method according to claim 1, configured for the aeronautical sector.

13. An aluminum or aluminum alloy part configured for the aeronautical sector and treated a post-ionization sealing method according to claim 1, wherein the aluminum or aluminum alloy part is surface treated by a surface treatment method comprising the steps of:.
i) subjecting said part to an anodization step, having possibly previously undergone a surface preparation step (degreasing, then pickling);
ii) treating the anodized part by a post-anodization sealing method according to the method of claim 1; and
iii) applying one or more layers of paint.

14. The method according to claim 10, further comprising the step of applying a HAO treatment on at least one portion of a functional areas of the part.
